(19) United States
(12) Patent Application Publication
(10) Pub. No.: US 2009/0028529 A1
(43) Pub. Date: Jan. 29, 2009

(54) Managing Recording of Television Programs

(75) Inventor: Kevin C. Kuhns, Suwanee, GA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/829,188

(22) Filed: Jul. 27, 2007

(51) Int. Cl. H04N 7/26

(52) U.S. Cl. 386/124; 386/E05.001

(57) ABSTRACT

Described herein are systems and methods for providing consumers with intelligent management of their personal or digital video recorders (DVRs) to efficiently utilize the data storage medium therein for recording television programs. This is made possible by the creation of a permanent log of previous-recorded content on the DVR based on common, unique content identification or associated metadata, which then allows the consumers to better manage DVR recording of selected content.

### BACKGROUND

With the advent of digital television services, such as digital cable, digital satellite, and over-the-air high definition television services, the digital or personal video recorder (DVR) has gradually replaced the old-fashioned video cassette recorder (VCR) as the tool of choice for recording television programs. As referred herein, television programs or content include but are not limited to programs (including audio, video, and/or multimedia programs) provided by television broadcasting networks, pay-per-view (PPV) programming events or content, and video-on-demand (VOD) programming events or content.

The DVR may be deployed or installed as a data storage medium (DSM), with associated software, in a standalone device or in a number of host devices. For example, they may be found in set top boxes (STBs) for digital cable or satellite television programmings. They are also found in digital versatile disc (DVD) players and recorders, digital television sets. In another example, the DVR may be implemented as a DSM (with associated software) in multimedia personal computers (PCs). A typical example of a DSM is a magnetic hard disk drive (HDD) or any other electronic data storage device. As the DVR becomes more popular with consumers, its role as an important tool for defining or establishing viewing preferences is increasing.

### BRIEF DESCRIPTION OF THE DRAWINGS

Embodiments are illustrated by way of example and not limited in the following figure(s), in which like numerals indicate like elements, in which:

FIG. 1 illustrates a host device with a personal or digital video recorder installed therein;

FIG. 2 illustrates a data storage medium in a personal or digital video recorder;

FIG. 3 illustrate a method for intelligently managing the recording of television programs with a personal or digital video recorder; and

FIGS. 4A-B illustrate another method for intelligently managing the recording of television programs with a personal or digital video recorder.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

As consumers become more adept at using DVR features, their personal usage of the DVR migrates from recording only specially-selected television programs to viewing most of their preferred television programs as recorded content. Managing the space allocation in the DVR for recording content, such as television program series and specific programs by title, is typically done by the consumer or DVR user. Thus, periodically, when the DVR's data storage medium or DSM is full, the user may purge the storage space of previously-recorded content to make room for storing user-defined fresh content. The user may store selected fresh content manually (e.g., by pressing a DVR record button to record a currently-viewed program) or automatically (e.g., by presetting recording preferences with DVR recording timers). Many television program series are repeated throughout the year such that the same unique episode of a series may appear in an electronic program guide (EPG) for broadcasting a number of times in a year. Thus, without any intelligent management of the DVR recording features, its preset recording preferences will simply re-record previously-recorded content that may already have been viewed by the user. During seasonal spikes of programming reruns, such as in the summer, this may rapidly fill the DSM with unwanted, previously-recorded content.

Consequently, it is desirable to provide consumers with an intelligent way to manage their DVRs to ensure that a continuous supply of user-defined fresh content is available for viewing, while previously-recorded or already-viewed content is not re-recorded by the DVRs. Accordingly, described herein are systems and methods for providing consumers with intelligent management of their DVRs to efficiently utilize the data storage medium (DSM) therein for recording television programs.

### System

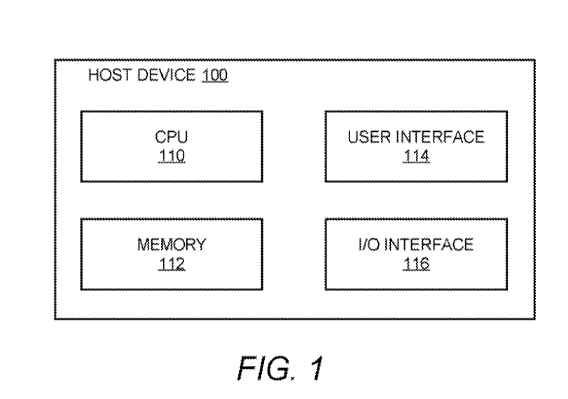

FIG. 1 illustrates a host device 100, such as a STB, with a DVR installed therein. The host device 100 includes, among other components, a central processing unit (CPU) 110, a memory 112, a user interface 114, and an I/O interface 116. A communication bus (not shown) may be implemented to provide connections between the aforementioned components and other components in the host device 100 in a known manner. It should be understood that the host device 100 may be a standalone DVR or a device other than a STB and may be implemented using any known hardware and software (including firmware).

The CPU 110 includes one or more processors of any of a number of computer processors, such as processors from Intel, AMD, or Cyrix. Each processor is coupled to or includes at least one memory device, such as a data storage medium (DSM). The processor is operable to execute computer-executable program instructions stored in the DSM, such as program code of applications, to run the applications. The computer-executable program instructions include code from any suitable computer-programming language, such as C, C++, C#, Java, or the like.

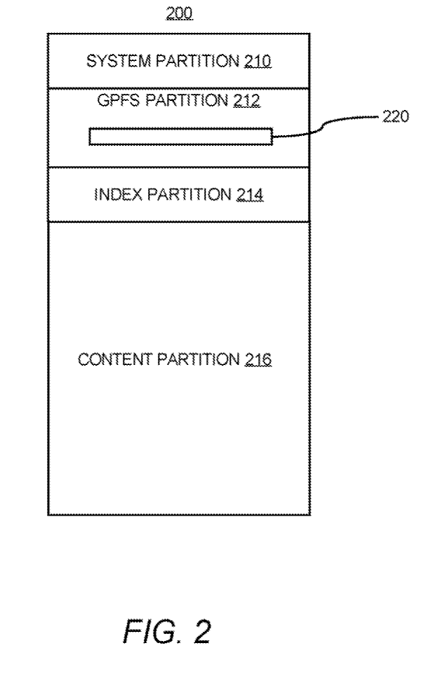

The memory 112 may be implemented as a DSM having stored thereon software applications, programs, or modules. These software applications include computer executable instructions that provide any number of functions and operations of the host device 100. The memory 112 also provides space for storing recorded television programs. Examples of a DSM for the memory 112 include but are not limited to an electronic, optical, magnetic, or other storage device capable of storing data content and providing a processor, such as the CPU 110, with computer-readable instructions. Thus, the DSM may be a computer-readable medium. Other examples of a suitable DSM include, but are not limited to, a floppy disk, CD-ROM, DVD, magnetic disk, memory chip, ROM, RAM, an ASIC, any optical medium, any magnetic tape or magnetic medium, or any other medium from which a computer processor is operable to read instructions. The memory 112 is further described below with reference to FIG. 2.

In one example, the memory 112 includes software applications that may be executed by the CPU 110 to provide DVR functionalities such as program recording, program playback (e.g., pause, rewind, forward), and recording timers. The memory 112 also includes software applications that may be executed by the CPU 110 to receive, store, and display an electronic program guide (EPG) from a television service provider, such as a cable or satellite television service provider. The EPG may be stored in a database that also resides in the memory 112 or any other suitable storage space in the host device 100. As referred herein, an EPG provides information or metadata about the television programs that are available for viewing by the user. The available television programs include programs provided by television broadcasting networks, pay-per-view (PPV) programs, and video-on-demand (VOD) programs. Thus, information or metadata of a program as provided by an EPG may include a text summary of the programming event, classification of the program, the channel and time for the program, and any other information that describes or identifies the program. The software applications also enable the host device to receive and display the programs (e.g., network television broadcasts, PPVs, VODs) on one or more television channels.

The user interface 114 allows a user to enter commands, e.g., to view the programming services and applications available from the host device 100, using a conventional interface device, such as a hand held remote control. An appropriate graphical user interface (GUI) may be provided on a display, such as a television, via a display adapter (not shown) for this purpose. The user may also define or modify parameters of the host device 100, such as security policy data for the device, through the user interface 114.

The Input/Output (I/O) interface 116 enables the host device 100 to communicate with the television service provider in a known manner to send and receive signals to the television service provider. Thus, the I/O interface 116 may include, for example, a tuner for tuning to different television channels and a modem for modulating signals to be sent to the television service provider and demodulating signals received from the television service provider.

FIG. 2 illustrates further details of the memory 112. The memory 112 is implemented as a DSM 200, such as a hard disk drive (HDD). The DSM 200 includes a plurality of memory partitions, such as a system partition 210, a general purpose file system (GPFS) partition 212, an index partition 214, and a content partition 216. For example, as a HDD, the DSM 200 is initially subjected (typically at the factory) to HDD partitioning to create HDD partitions for 210, 212, 214, and 216 and any other desired partitions. The system partition 210 includes hardware-specific files that are used to start an operating system for the host device 100 generally and the DVR therein specifically. The GPFS partition 212 implements a file system for storing and organizing general-purpose data and content files in the content partition 216. The index partition 214 provides indices for the partitioning of the DSM 200 and the files in the content partition 216 as organized by the file system implemented in the GPFS partition 212. The content partition 216 provides space for storing recorded television program files as well as software applications for operating the host device 100 and DVR therein.

To provide users with intelligent management of the DVR recording features, a content history file 220 is created in a persistent storage area of the DSM 200, such as the GPFS partition 212. A persistent storage area is desired for the content history file 220 to prevent an accidental erasure of such a file. The content history file 220 may be a simple text-based file, a database file, or a extensible markup language (XML) file that maintains a list of all television programs that were previously recorded on the DVR. Thus, the content history file 220 is relatively small in size (e.g., ˜10 MB) with respect to the overall storage space of the DSM 200 (e.g., ˜80-300 GB). The recorded television programs may be identified in the previously-recorded list by any one or more of a number of available metadata that describes such programs in the EPG or is embedded in the television programs. Examples of the program metadata that may be used as unique program identifiers include but are not limited to: international standard audiovisual number (ISAN) embedded in each television program or listed in the EPG for the program, program title, program description, episode number of a program series, year of first broadcasting of the program, or any other program identification (ID). The content history file 220 is appended each time a new television program is stored. In addition, the content history file 220 is not deleted when the television program itself is deleted or purged from the DSM 200 so that the recording history of such a program remains intact and stored. Thus, when the user subsequently sets recording preferences for a specific television program or a program series to be saved on the DSM 200, the content history file 220 may be checked to verify that the specific program or any episode in the program series is not a member of the previously-recorded list.

The content history file 220 may be used in conjunction with other available DVR recording preferences to enhance the management of DVR recorded programs. For example, an available DVR recording preference may provide the user with a choice to record only new episodes in a television program series. Information as to whether an episode is a new one or a re-run may be found in the episode description in the EPG. Thus, in conjunction with the content history file 220, the user is able to record not only new episodes in the current season but also old episodes of the program series from previous seasons or prior to a user-selected date, wherein only those old episodes that were not previously recorded by the DVR are actually recorded based on the previously-recorded list in the content history file 220.

### Process

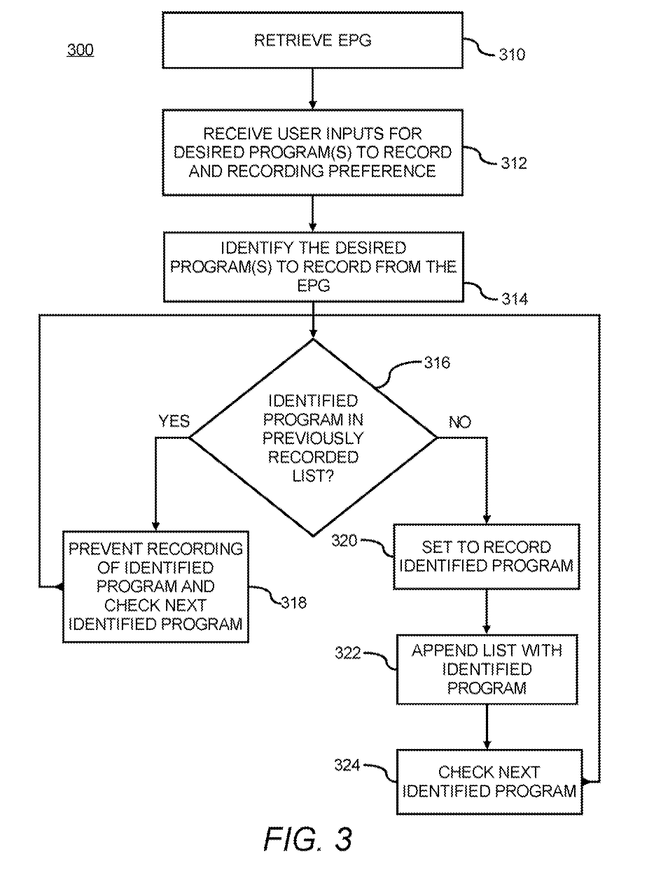

FIG. 3 illustrates a process or method 300 for intelligently managing the recording of television programs with a DVR. For illustrative purposes only and not to be limiting thereof, the method 300 is discussed in the context of the system 100 (FIGS. 1 and 2).

At 310, the host device 100 retrieves, receives, downloads, or otherwise obtains an EPG from a television service provider and stores the EPG in the memory 112 or any other desired storage space in the host device 100. On a periodic basis, the retrieval and storage of the EPG may be automatically executed or prompted by the user. For example, the host device 100 may be scheduled to receive an updated EPG on a weekly, daily, or hourly basis.

At 312, the host device 100 provides the user with the ability to select a desired television program or program series for recording and to set up a preset preference for recording such a program or program series. The program selection and recording preferences may be accessed by the user through an available graphical user interface (GUI), as provided by the user interface 114, which may also provide the user with access to the EPG. For example, the program selection and recording preferences include an option to record a specific movie (e.g., “Star Wars”) or a program series (e.g., “Law & Order” television series) as found in the EPG that were not previously recorded by the host device 110 (via the DVR therein).

At 314, based on the program selection at 312, the EPG stored in the memory 112 is searched to identify the user-selected television program or episodes of the user-selected program series for recording. As discussed earlier, a unique identifier for each television program or episode may be found in its metadata as stored in the EPG. Thus, for example, if the user inputs include a preference for recording only episodes of “Law & Order” that were not previously recorded, regardless whether such episodes are new or re-runs (i.e., user-defined fresh content), the EPG is searched to identify each and every “Law & Order” episode for subsequent look up in the content history file 220 as described next.

At 316, when the user's preset recording preference at 312 is to record fresh content as defined by the user, for example, those programs or episodes not previously recorded, the program identifier for each identified program or episode is looked up in the previously-recorded list stored in the content history file 220, to determine whether such a program was previously recorded.

At 318, if a program identifier is found in the previously-recorded list, its associated program or episode is prevented from being recorded by the DVR, and the method 300 is repeated at 316 to check the next identified program or episode.

Otherwise, at 320, the associated program or episode is set to be recorded at its appointed time in accordance with the EPG and stored as a file in the content partition 216 of the DSM 200, whereby the stored file is organized by the file system, as implemented in the GPFS partition 212, and indexed in the index partition 214.

At 322, the content history file 220 is subsequently appended with the program identifier of the program or episode upon its recording by the DVR.

At 324, the method 300 is repeated at 316 for the next identified program or episode.

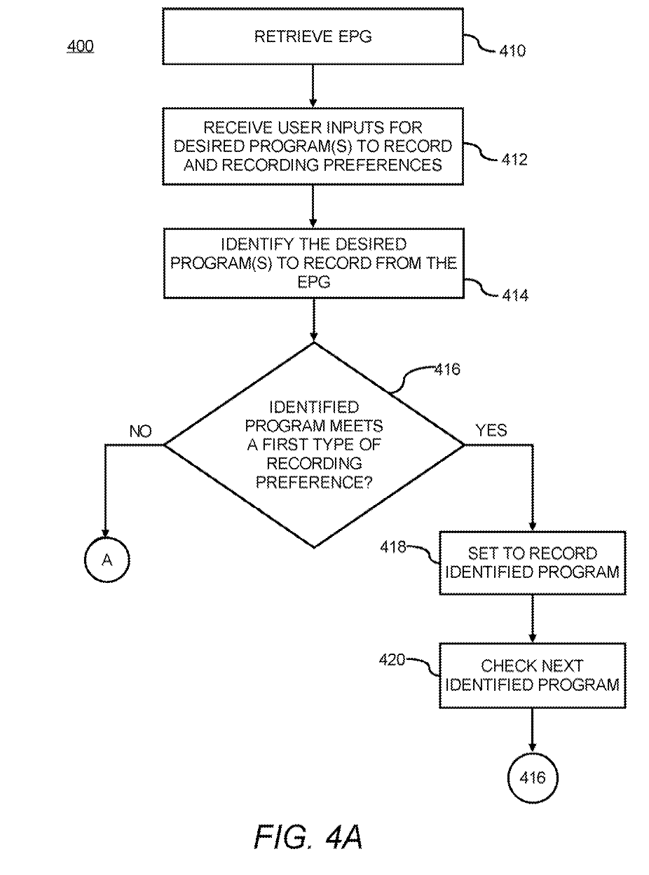

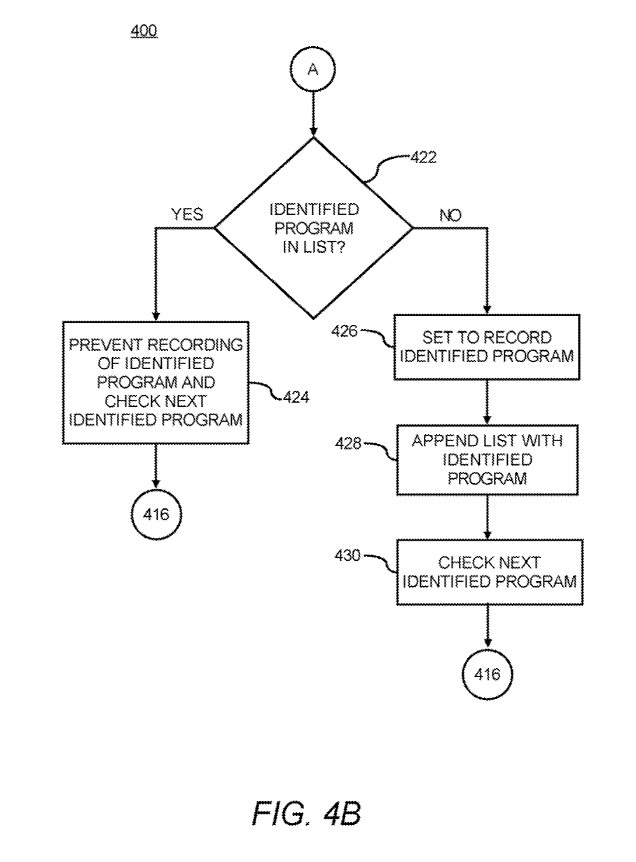

The method 300 may be used in combination with other available types of DVR recording preferences that do not require the use of the content history file to enhance the management of DVR recorded programs. Examples of other types of DVR recording preferences include a reference to record all new or previously-not-aired programs (in which case they would not have been recorded and documented in the content history file, and such a recording preference would not desire such a file) and programs that were previously-aired during a desired time frame (in which case, such a recording preference would override the content history file and would not desire such a file). FIG. 4 illustrates such a combined method 400 that includes a recording preference to record new programs.

At 410, the EPG is retrieved as described above at 310 in FIG. 3.

At 412, the host devices 100 provides the user with the ability to select a desired television program or program series for recording and to set up a plurality of preset preferences for recording such a program or program series. Again, the program selection and recording preferences may be accessed by the user through an available GUI provided by the user interface 114. For example, the program selection and preset recording preferences include an option to record not only new episodes of the “Law & Order” television series but also re-run episodes that were originally broadcasted prior to the current television season.

Accordingly, at 414, based on the user's program selection of the desired program or program series to record at 412, the EPG stored in the memory 112 is searched to identify the user-selected television program or episodes of the user-selected program series for recording. As discussed earlier, a unique identifier for each television program or episode may be found in its metadata as stored in the EPG. For example, when the user's program selection is the “Law & Order” television series, the EPG is searched to identify each and every “Law & Order” episode with a program identifier.

At 416, a determination is made as to whether each identified program or episode meets or satisfies a first type of the preset recording preferences that does not use the content history file. For example, for a first preset recording preference to record only those “Law & Order” episodes that are new, a determination is made as to whether an identified television program or episode is new based on its metadata found in the EPG.

At 418, if the identified program or episode meets the first preset recording preference, for example, it is a new “Law & Order” episode, the identified program or episode is set to be recorded at its appointed time in accordance with the EPG and stored as a file in the content partition 216 of the DSM 200 as described above at 320 in FIG. 3.

At 420, the method 400 is repeated at 416 to check the next identified program or episode.

However, at 422, if the identified program or episode does not meet the first type of preset recording preference, a second determination is made as to whether the identified program or episode meets the second type of preset recording preference that uses the content history file. When the second present recording preference is to record fresh content as defined by the user, such as programs or episodes not previously recorded, the program identifier for each identified program or episode is further looked up in the previously-recorded list stored in the content history file 220 to determine whether such a program or episode is fresh content as defined by the user. For example, if the second preset recording preference is any re-run “Law & Order” episodes that were originally aired or broadcasted prior to the current television season (or some user-defined date), only those episodes originally aired prior to the current television season are looked up in the content history file 220 to check if they were previously recorded.

At 424, if a program identifier is found in the previously-recorded list, its associated program or episode will not be recorded by the DVR, and the method 400 is repeated at 416 to check the next identified program or episode.

Otherwise, at 426, the associated program or episode is set to be recorded at its appointed time in accordance with the EPG and stored as a file in the content partition 216 of the DSM 200, whereby the stored file is organized by the file system, as implemented in the GPFS partition 212, and indexed in the index partition 214.

At 428, the content history file 220 is subsequently appended with the program identifier of the program or episode upon its recording by the DVR.

At 430, the method 400 is repeated at 416 for the next identified program or episode.

In recap, the systems and methods as described herein provide an effective mechanism for ensuring that only user-defined fresh content is recorded by the DVR. This is made possible by the creation of a permanent log of previous-recorded content on the DVR based on common, unique content identification or associated metadata, which then allows the users to better manage DVR recording of selected content.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for managing the recording of television programs with a digital video recorder (DVR), the method comprising:
downloading an electronic program guide (EPG) to the DVR;
providing a list identifying any previous-recorded program in the DVR that has since been deleted;
receiving a user selection of a first television program to record to the DVR;
identifying the first television program with a first program identifier from the EPG;
determining whether the first program identifier is included in the provided list; and
upon the determining that the first program identifier is included in the provided list, preventing a recording of the first television program to the DVR.

2. The method of the claim 1, further comprising:
upon the determining that the first program identifier is not included in the provided list, setting the DVR to record the first television program; and
appending the provided list with the first program identifier.

3. The method of claim 2, further comprising:
receiving a user input of a second television program to record to the DVR;
identifying the second television program with a second program identifier from the EPG;
determining whether the second program identifier is included in the appended list; and
upon the determining that the second program identifier is included in the appended list, preventing a recording of the second television program to the DVR.

4. The method of claim 2, further comprising:
maintaining the appended list in the DVR upon a removal of a recording of the first television program from the DVR.

5. The method of claim 1, wherein receiving the user selection of the first television program to record to the DVR comprises:
receiving a user input of a television program series to record to the DVR;
receiving a user input of at least one recording preference for recording episodic programs in the television program series to the DVR; and
determining the received user selection of the first television program as one of the episodic programs based on the user input of the at least one recording preference.

6. The method of claim 5, wherein receiving the user input of at least one recording preference comprises:
receiving the user input of a first recording preference and a second recording preference, wherein one of the first and second recording preferences is based on the provided list.

7. A method for managing the recording of content with a content recorder, the method comprising:
downloading an electronic guide of available content for recording to the content recorder;
providing a list identifying any previously-recorded content in the content recorder;
receiving a first user input of a first recording preference to record content in the content recorder;
receiving a second user input of a second recording preference to record content in the content recorder, the second user input is based on the provided list;
receiving a third user input of a first content for recording to the content recorder;
identifying the first content with a first program identifier provided by the electronic guide for the first content;
first determining whether the identified first content satisfies a first type of recording preference; and
upon the first determining that the identified first content fails to satisfy the first recording preference, second determining whether the identified first content satisfies the second recording preference; and
upon the second determining that the identified first content satisfies a second type of recording preference, setting the content recorder to record the identified first content.

8. The method of claim 7, further comprising:
upon the first determining that the identified first content satisfies the first type of recording preference, setting the content recorder to record the identified first content.

9. The method of claim 7, further comprising:
upon the second determining that the identified first content fails to satisfy the second type of recording preference, preventing a recording of the first content to the content recorder.

10. The method of claim 7, wherein first determining whether the identified first content satisfies the first type of recording preference comprises:
determining whether the identified first content is a new episode of a television program series; and
indicating that the identified first content satisfies the first recording preference upon the determining that the identified first content is a new episode of a television program series.

11. The method of claim 10, wherein second determining whether the identified first content satisfies the second type of recording preference comprises:
determining whether the identified first content is an episode of the television program series that was previously broadcasted prior to a predetermined date; and
upon the determining that the identified first content is an episode of the television program series that was previously broadcasted prior to a predetermined date, determining whether the first program identifier for the identified first content is included in the provided list.

12. The method of claim 7, wherein second determining whether the identified first content satisfies the second type of recording preference comprises:
determining whether the first program identifier is included in the provided list;
indicating that the identified first content satisfies the second type of recording preference when the first program identifier is not included in the provided list.

13. The method of claim 1, wherein providing a list identifying any previous-recorded program in the DVR comprises:
providing a list identifying any previous-recorded program in the DVR that has since been deleted.

14. The method of claim 7, wherein providing a list identifying any previous-recorded content in the content recorder comprises:
providing a list identifying any previously-recorded content in the content recorder that has since been deleted.
